(19) United States
(12) Patent Application Publication
(10) Pub. No.: US 2005/0158470 A1
(43) Pub. Date: Jul. 21, 2005

(54) Spray head applicator, dispensing systems, and methods of use

(76) Inventor: Nicholas Maiorino, Branford, CT (US)

Correspondence Address: UNITED STATES SURGICAL,;A DIVISION OF TYCO HEALTHCARE GROUP LLP, 150 GLOVER AVENUE, NORWALK, CT, 06856, US

(21) Appl. No.: 10/984,563

(22) Filed: Nov. 9, 2004

Related U.S. Application Data
(60) Provisional application No. 60/519,181, filed on Nov. 11, 2003.

(51) Int. Cl. B05D 3/12

(52) U.S. Cl. 427/256

(57) ABSTRACT

A system for dispensing a quantity of a coating material is disclosed. The system includes a dispensing head assembly maneuverable over a target object, and a purge cup operatively positioned relative to the dispensing head assembly. The purge cup defines a cavity for receiving a quantity of a solvent therein, wherein a nozzle of the dispensing head is positioned in the cavity of the purge cup when the system is in an idle condition.

### CROSS-REFERENCE TO RELATED APPLICATIONS

The present application claims the benefit of and priority to U.S. Provisional Application Ser. No. 60/519,181, filed on Nov. 11, 2003, the entire contents of which are incorporated herein by reference.

### BACKGROUND

1. Technical Field

The present disclosure relates to spray head applicators, dispensing systems, and methods for selective application of materials to objects and, more particularly, to spray head applicators, dispensing systems, and methods for use in applying a selected coating to a tray of surgical-type needles.

2. Background of Related Art

Spraying may be one of the most commonly used methods employed in applying coatings of material to surgical needles. Spraying can be categorized as either air spraying in which an air stream is impinged against a stream of liquid coating material after leaving the spray nozzle to form an atomized spray pattern, or airless spraying in which the coating material is dispensed as a nonatomized spray pattern.

An important factor in spray coating is the amount or quantity of coating material dispensed onto the target material, e.g., trays of surgical-type needles and the like.

Accordingly, a continuing need exists for improvements in spray head applicators, dispensing systems and methods of using the same.

### SUMMARY

Methods of fabricating surgical-type needles are disclosed. Systems for dispensing a quantity of a coating material are disclosed. According to one aspect of the present disclosure, a system for dispensing a quantity of a coating material includes a dispensing head assembly maneuverable over a target object, and a purge cup operatively positioned relative to the dispensing head assembly. The purge cup defines a cavity for receiving a quantity of a solvent therein, wherein a nozzle of the dispensing head is positioned in the cavity of the purge cup when the system is in an idle condition.

It is envisioned that the dispensing system includes a supply of coating material operatively associated with the dispensing head assembly. Preferably, the coating material can include a silicone based coating material including and not limited to a coating mixture comprising at least one polydialkylsiloxane having a molecular weight of at least about 10,000 cp and at least one other siliconization material (e.g., aminoalkyl siloxane and at least one other siloxane copolymerizable therewith, polydimethylsiloxane having amino and alkoxy functional groups).

It is further envisioned that the dispensing system includes a gravity feed system for determining the amount and/or quantity of the coating material to be dispensed to the target object. The gravity feed system includes a scale for supporting the supply of coating material. The amount and/or quantity of the coating material to be dispensed can be calculated from the decrease in weight of supply of coating material. Preferably, the gravity feed system can be calibrated to dispense about 19 grams of coating material for a target object including a plurality of surgical needles each having a thickness of 0.012 to about 0.067 inches. In addition, the gravity feed system can be calibrated to dispense about 16 grams of coating material for a target object including a plurality of surgical needles each having a thickness of about 0.006 to about 0.011 inches.

The gravity feed system can include a scale for measuring the decrease in the weight of the supply of coating material. An algorithm can be provided to convert the loss in weight of the supply of coating material to the quantity of coating material dispensed.

It is envisioned that the target object includes a plurality of needles and/or a tray having a plurality of needles connected thereto.

It is envisioned that a conveyor can be provided to carry the target object thereon. It is further envisioned that a hood can be provided to surround the target object during the dispensing of the coating material.

Desirably, a solvent is disposed in the cavity of the purge cup. The solvent is of the type for inhibiting clogging of a distal end of the dispensing head assembly when the distal end of the dispensing head assembly is disposed in the solvent contained in the purge cup.

According to another aspect of the present disclosure, a method of coating a target object is provided. The method of coating of the target object includes providing a dispensing system including a dispensing head assembly, a supply of coating material operatively connected to the dispensing head assembly, and a purge cup containing a quantity of a solvent therein and for retaining a portion of the dispensing head assembly therein when the dispensing system is idle.

The method further includes the steps of removing the dispensing head assembly from the solvent of the purge cup, positioning the dispensing head assembly over a target object, dispensing a predetermined quantity of coating material onto the target object, maneuvering the dispensing head assembly over the target object in a predetermined pattern, and returning the dispensing head assembly to the purge cup such that a distal end portion of the dispensing head assembly is submerged below the surface of the solvent.

The method can further include the step of the gravity feed system terminating the dispensing of the coating material after a predetermined amount of coating material has been dispensed. The gravity feed system can include a scale for measuring the decrease in the weight of the supply of coating material. An algorithm can be provided to convert the loss in weight of the supply of coating material to the quantity of coating material dispensed. Accordingly, the method can further include the step of transmitting a “no go” signal, from the gravity feed system to the dispensing system, when the predetermined quantity of coating material has been dispensed, to terminate the dispensing of the coating material.

According to another aspect of the present disclosure, a dispensing system for dispensing a quantity of a coating material, is disclosed. The dispensing system includes a dispensing head assembly having a sleeve defining a material supply passageway to receive the coating material; an inner barrel disposed within the sleeve and defining an air passageway between the sleeve and the inner barrel; and a nozzle operatively supported on a distal end of the sleeve in a fluid tight manner, the nozzle having an orifice through which coating material from the supply passageway is dispensed, the nozzle having an annular flange with air ports formed therein and in fluid communication with the air passageway. The dispensing system further includes a reservoir for containing a supply of coating material fluidly connected to the dispensing head assembly; and a gravity feed system including a scale for supporting the supply of coating material, wherein the gravity feed system determines the quantity of coating material dispensed from the dispensing head assembly.

The dispensing system may further include a purge cup including a solvent material therein. Accordingly, in use, the nozzle is disposed within the solvent of the purge cup when the dispensing head assembly is idle. The solvent material desirably reduces the exposure of the nozzle to ambient moisture and minimizes silicon cross linking of the coating material.

The gravity feed system desirably includes a cut-off circuit for regulating the quantity of coating material dispensed from the reservoir. The cut-off circuit transmits a “go” signal when coating material is to be dispensed and a “no go” signal when coating material is not to be dispensed. The cut-off circuit desirably monitors the scale during dispensing of the coating material from the reservoir. As such, when the scale reaches a threshold level, the cut-off circuit transmits a “no go” signal and terminates dispensing of the coating material from the reservoir.

Desirably, the solvent is at least one of a hydrocarbon solvent of from about 5 to about 10 carbon atoms, an alcohol, a hexane, a heptane, and an isopropanol.

These and other aspects and advantages of the present disclosure will be apparent to those skilled in the art from the following description of the preferred embodiments in view of the accompanying drawings.

### BRIEF DESCRIPTION OF THE DRAWINGS

The structure, operation, and advantages of the presently preferred embodiment of the disclosure will become further apparent upon consideration of the following description taken in conjunction with the accompanying drawings, wherein:

FIG. 1 is a side view of a prior art dispensing head assembly, suitable for use with the present disclosure;

FIG. 2 is a longitudinal cross-sectional view of the dispensing head assembly of FIG. 1 as taken along line A-A of FIG. 1;

FIG. 3 is an enlarged side elevational view of the indicated area of FIG. 2;

FIGS. 4A and 4B are enlarged cross-sectional side elevational views of the distal end of the dispensing head assembly of FIGS. 1 and 2, illustrating the dispensing head assembly in an unassembled (FIG. 4A) and an assembled condition (FIG. 4B);

FIG. 5 is a schematic perspective view of a dispensing system in accordance with an embodiment of the present disclosure using the dispensing head assembly of FIGS. 1 and 2;

FIG. 6 is a diagrammatic view illustrating use and/or operation of the dispensing system of FIG. 5; and

FIG. 7 is an enlarged perspective view of the dispensing head assembly of dispensing system of FIGS. 5 and 6 disposed in a purge cup.

### DETAILED DESCRIPTION OF PREFERRED EMBODIMENTS

Preferred embodiments of the presently disclosed spray head applicator, dispensing systems and methods of use will now be described with reference to the drawing figures wherein like reference numerals identify similar or identical elements. In the drawings and in the following description, the term “proximal”, as is traditional, will refer to the end of the element which is closer to the operator, while the term “distal” will refer to the end of the apparatus which is further away from the operator.

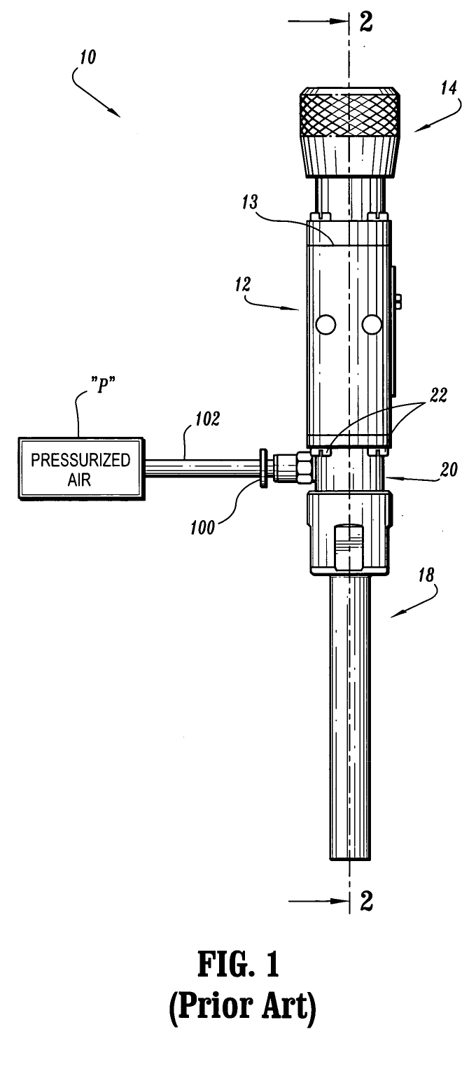

With reference to FIGS. 1-4B, a prior art dispensing head assembly 10, for use with a dispensing system, is illustrated such as can be used with the concepts of the present disclosure. In general, dispensing head assembly 10 is operatively connected to a supply of air “P” in order to be able to effect an air assisted spray pattern. The design and specific operation of dispensing head assembly 10 is fully described in U.S. Pat. No. 6,244,522, the entire contents of which are incorporated herein by reference.

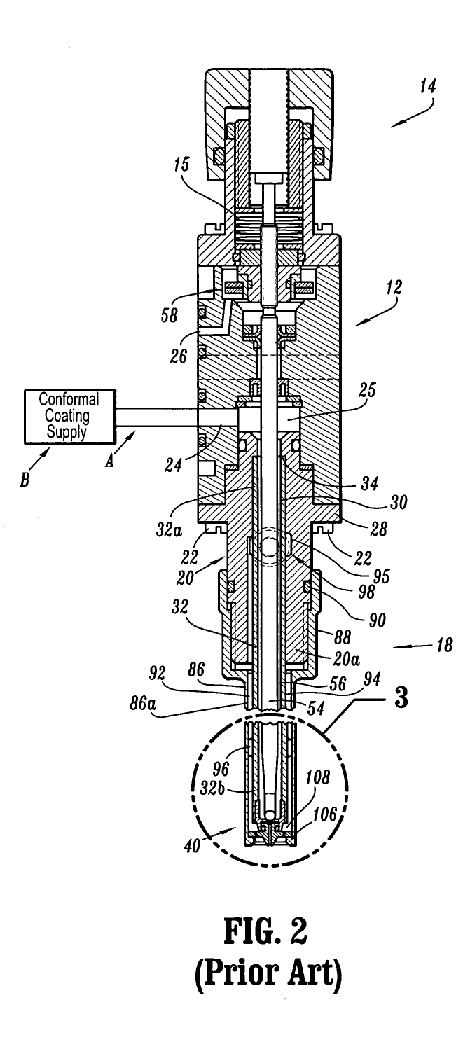

Dispensing head assembly 10 includes a main dispenser body 12 which, at a first end 13 thereof, has a valve plunger return and adjustment mechanism 14 mounted thereto. Dispensing head assembly 10 further includes a barrel assembly 18 including a sleeve 20 that is mounted to the main body 12, opposite the first end 13. The barrel assembly 18 includes a nozzle and nozzle seat, as well as inner and outer barrels or tubes, as will be further explained in connection with FIG. 2.

With reference next to FIG. 2, the dispensing head assembly 10 is shown in longitudinal cross-section. For clarity, a manifold for connecting the dispensing head assembly 10 to a source of coating material and to a source of pressurized air for actuating plunger mechanism 14 is omitted from the drawings herein. For a detailed discussion of the manifold, reference can be made to U.S. Pat. No. 5,336,320, the entire contents of which are incorporated herein by reference.

For purposes of the present disclosure, it is sufficient to note that the coating material is introduced into dispensing head assembly 10 via an inlet port 24, and actuating pressurized air is introduced into mechanism 14 via an air port 26. The coating material passes into a cavity 25 and then down into a feed bore as will be described hereinafter. A supply hose “A” is connected at one end to port 24 by any suitable fitting (not shown), as is well known in the art, and at the other end to a supply “B” of the material being dispensed (i.e., the coating material).

With continued reference to FIG. 2, sleeve 20 of barrel assembly 18 includes a flange 28 for mounting sleeve 20 onto main body 12 via bolts 22. Sleeve 20 has a central bore 30 that receives a first end (32a) of a first or inner barrel or material feed tube 32. Inner barrel 32 slides up into sleeve 20 and bottoms on a counterbore shoulder 34 thereof. Inner barrel 32 extends to an opposite nozzle seat end 32b.

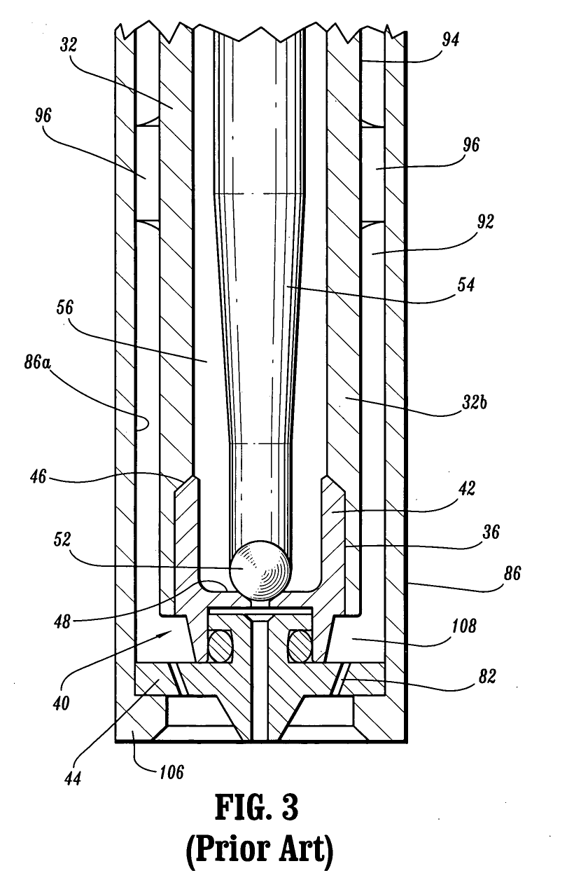

With reference also to FIG. 3, nozzle end 32b of inner barrel 32 has a nozzle seat recess 36 formed therein. Recess 36 is in the form of a counterbore, however, for example, barrel 32 can be provided with any configuration that is suitable for retaining a nozzle seat, or the seat could be integrally formed therewith.

Dispensing head assembly 10 can include a two piece nozzle assembly 40. Nozzle assembly 40 includes a nozzle seat 42 and a discharge nozzle 44. Nozzle seat 42 is received in recess 36 and is inserted until seat 42 engages a shoulder 46 where it is brazed or otherwise secured in place.

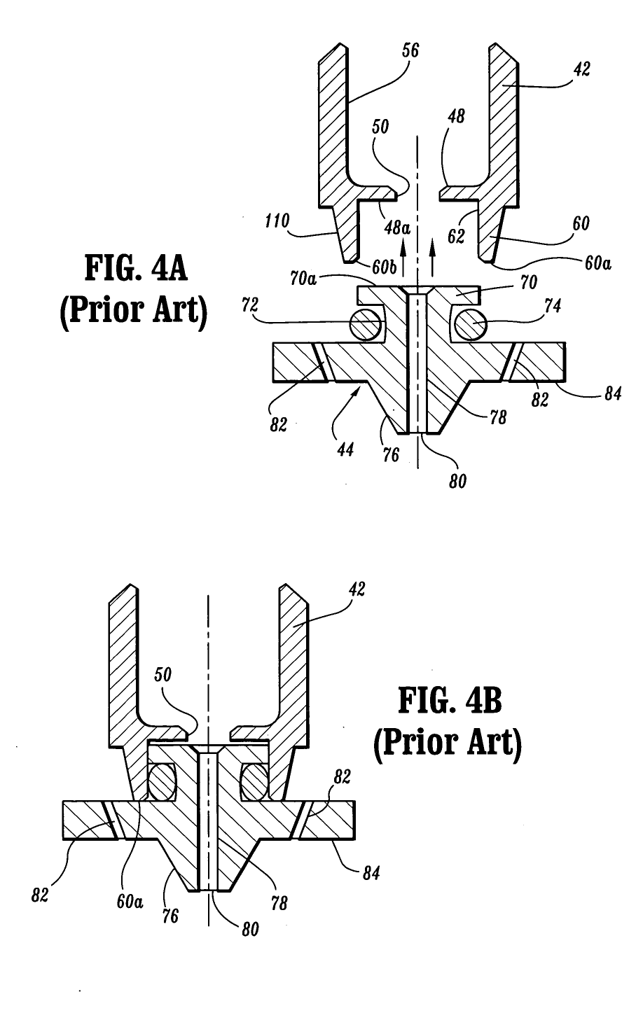

With additional reference to FIG. 4A, nozzle seat 42 is generally a cylindrical structure with an inwardly extending seat wall 48 having a central flow port 50 formed therethrough. Port 50 is opened and closed by a valve member 52, which can be realized in the form of a ball tip carried at an end of a valve plunger 54.

Plunger 54 is disposed within a central feed bore 56 of inner barrel 32. Plunger 54 is appropriately dimensioned so that there is sufficient space for coating material to flow from cavity 25, down barrel 32 to nozzle assembly 40. The coating material thus flows down inner barrel 32 through bore 56 along outside of plunger 54. When plunger 54 is retracted (not shown), the ball tip of valve member 52 unseats from seat wall 48 to open port 50, thus permitting material to flow through port 50 to the discharge nozzle 44.

With continued reference to FIGS. 2 and 4A, nozzle seat 42 includes a cylindrical extension 60 with a counterbore recess 62 formed therein. Recess 62 closely receives a central annular nozzle body stem 70 of discharge nozzle 44. Stem 70 has a seal groove 72 formed therein. A seal 74 is disposed on stem 70 in groove 72. Seal 74 preferably is retained within groove 72 sufficiently so as not to be dislodged when nozzle stem 70 is inserted into nozzle seat recess 62.

Discharge nozzle 44 further includes a tapered central tip 76 through which material is dispensed toward a target. A central dispensing bore 78 extends through nozzle 44 from stem 70 to tip 76. Material flowing from port 50, when valve 52 opens, is thus discharged through an outlet spray orifice 80.

Nozzle 44 also includes air jets 82 formed in an annular flange 84. Air jets 82 may be realized in the form of individual bores formed through flange 84 as illustrated. Preferably, jets 82 are precisely angled so as to direct air towards the material exiting orifice 80 to impart a swirling motion to the material flow pattern. This swirling motion is in the nature of a tornadic swirling motion to effect a thorough yet highly selective and controlled application of the conformal coating material on the target. Jets 82 are radially disposed outward of seat extension 60 so as to be open to a cavity that surrounds the outside of nozzle seat 42 as will be further described hereinafter.

FIG. 4B illustrates nozzle 44 fully inserted and seated in nozzle seat 42. Seal 74 effectively seals against material escaping from nozzle assembly 40 around stem 70, and also prevents air from passing up into feed bore 56. In other words, seal 74 separates the fluid material section or bore 56 from the air section or passage 92. Preferably, but not necessarily, flange 84 bottoms against lower wall 60a of seat extension 60 before stem 70 upper wall 70a bottoms against lower wall surface 48a of seat wall 48. Nozzle 44 can be inserted into seat 42 by pushing nozzle 44 up into recess 62 with a slight twisting motion. Seat extension 60 may be chamfered as at 60b to help guide the nozzle stem 70 into recess 62 and to reduce the occurrence of damaging seal 74 during assembly.

With reference again to FIGS. 2 and 3, an outer barrel or tube 86 is generally concentrically disposed about inner barrel 32 and nozzle assembly 40. Outer barrel 86 includes an internally threaded tubular end 88 that is screwed onto an externally threaded end 20a of the sleeve 20. An O-ring 90 or other suitable sealing technique is used to seal this joint against loss of pressurized air.

Outer barrel 86 is appropriately sized so as to provide an air passage 92 between inner wall 86a of barrel 86 and outer wall 94 of inner barrel 32. Spacers 96 may be used in this air passage 92 to maintain concentric alignment of barrels 32, 86 along the axial extent thereof. Spacers 96 can also be used to impart a turbulent or swirling motion to the air flow.

Air passage 92 is an annulus that is in fluid communication with an air inlet port 98 that is coupled to an air inlet fitting 100. Fitting 100 connects with a conduit 102, e.g., an air hose, to feed air from pressurized air supply “P” to air passage 92.

Air passage 92 opens to a preferably but not necessarily enlarged air cavity 108. Air jets 82 also open to cavity 108. Valve seat 42 may be tapered as at 110 (FIG. 4A) to provide this enlarged air cavity. Jets 82 are preferably angled downward and radially to produce a rotating air pattern around discharge orifice 80. As the fluid that is dispensed from nozzle 40 enters the tornadic rotating air pattern, the fluid swirls and rotates to produce a desired spray pattern including a swirling atomized fluid spray pattern or a swirling monofilament fluid pattern

As illustrated in FIGS. 2 and 3, the nozzle end of outer barrel 86 has an inwardly extending shoulder or flange 106. Flange 106 engages flange 84 of nozzle 42 and securely holds nozzle 42 in place after outer barrel 86 is fully threaded and tightened down onto sleeve 20. The radial extent of outer barrel flange 106 is limited in order to prevent obstruction of air jets 82 and to prevent interference with the swirling air flow.

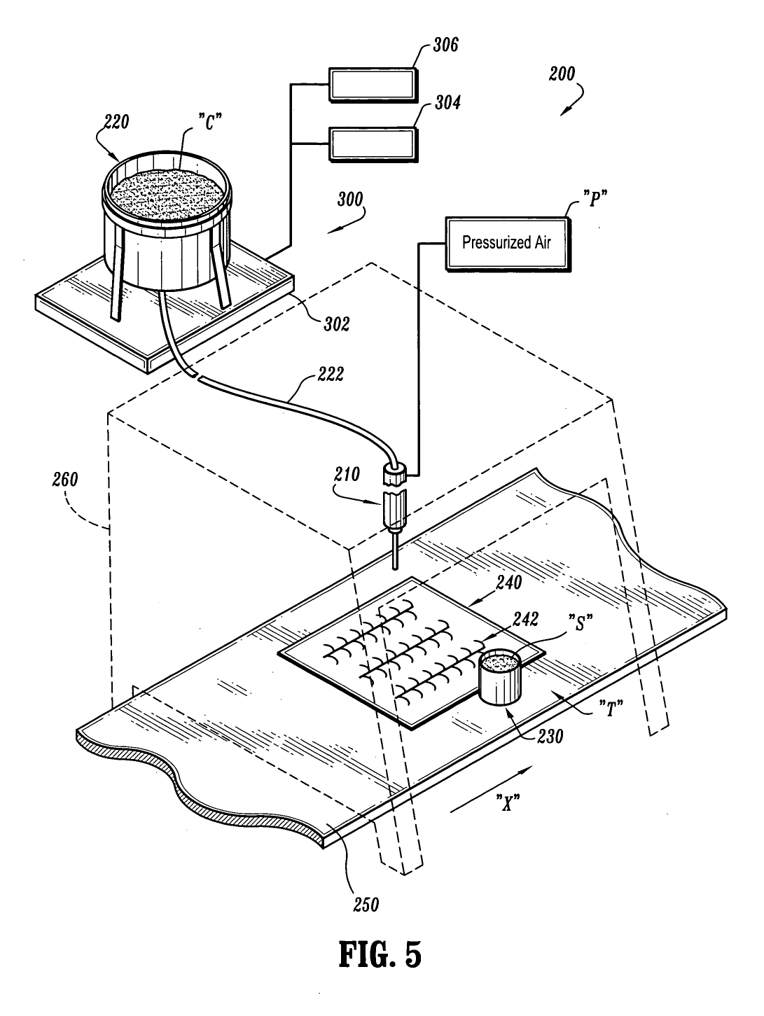

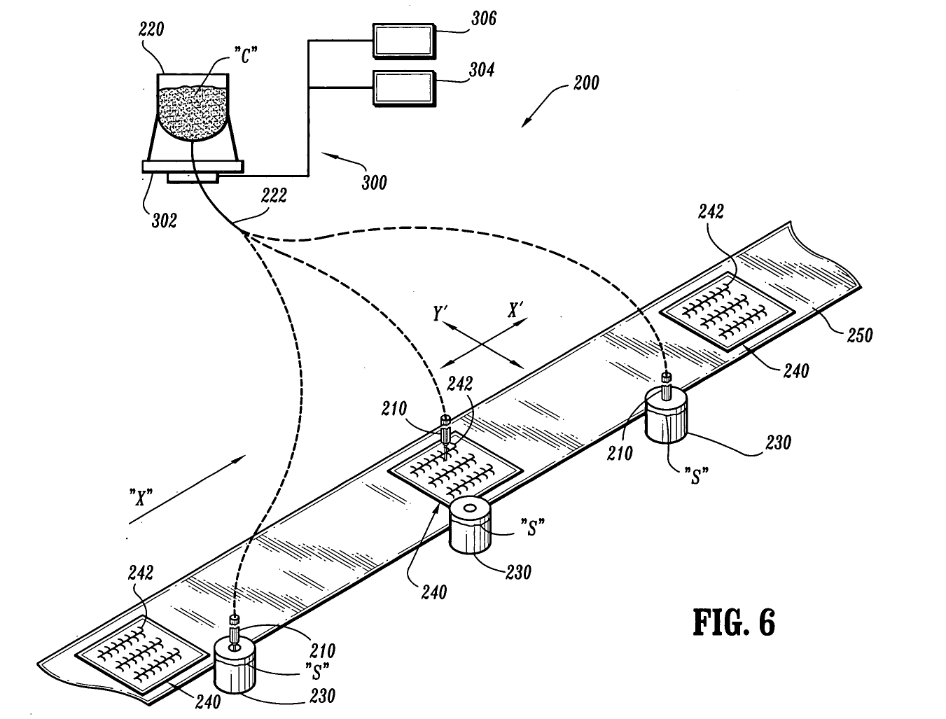

Turning now to FIGS. 5 and 6, a dispensing system 200 and a method of use of the same, in accordance with an embodiment of the present disclosure, will be described. Dispensing system 200 includes a dispensing head assembly 210, substantially similar to dispensing head assembly 10 described above, a reservoir or supply 220 of coating material “C” operatively connected to dispensing head assembly 210 (by, for example, a conduit 222), a source of pressurized air “P” operatively connected to dispensing head assembly 210, and a purge cup 230, containing a quantity of a solvent “S” therein, positioned in close proximity to a target site “T”.

Dispensing system 200 is configured and adapted to provide a tray of surgical needles 240, including a tree of surgical needles 242 or a plurality of individual needles (not shown), with a coating of material “C”. While the present disclosure illustrates and describes, in the interest of brevity, the use of dispensing system 200 on trays of surgical needles 240, it is envisioned and within the scope of the present disclosure for dispensing system 200 to be used, equally as well, on other types of suture needle productions or other types of applications.

Coating material “C” can include and is not limited to silicone based coating materials including a coating mixture comprising at least one polydialkylsiloxane having a molecular weight of at least about 10,000 cp and at least one other siliconization material (e.g., aminoalkyl siloxane and at least one other siloxane copolymerizable therewith, polydimethylsiloxane having amino and alkoxy functional groups). Other suitable coating materials are disclosed in U.S. patent appln. Ser. No. 09/964,901 filed on Sep. 27, 2001, entitled “Siliconized Surgical Needles and Methods for Their Manufacture”, the entire contents of which are incorporated herein by reference.

The amount of coating material “C” sprayed onto tray of needles 240 is determined by using a gravity feed system 300. Gravity feed system 300 includes a scale 302, on which supply 220 of coating material “C” is placed, and, optionally, an automated interface or computer 304 operatively connected with scale 302 for displaying the quantity of coating material “C” dispensed by dispensing system 200, for performing various algorithms, permutations, calculations and the like. Use and operation of gravity feed system 300 will be described in greater detail below.

Depending on the gauge and/or dimensions of the needles (e.g., wire sizes) to be coated and/or the thickness of the coating material “C” to be provided, gravity feed system 300 is calibrated and/or otherwise configured to dispense various quantities of the coating material “C” onto tray of needles 240. By way of example only, for a tray of needles having wire sizes of between about 0.012 to about 0.067 inches it is preferred that about 19 grams of coating material “C” is dispensed over the tray of needles, and for a tray of needles having wire sizes of between about 0.006 to about 0.011 inches it is preferred that about 16 grams of coating material “C” is dispensed over the tray of needles.

Gravity feed system 300 functions pursuant to lost volume and/or lost mass principles. In other words, in use, scale 302 is initially set to zero and as coating material “C” is dispensed from supply 220 of coating material “C”, the weight of supply 220 is decreased by a quantifiable amount. Then, using known formulas, algorithms and calculations, the quantifiable amount of decrease in the weight of supply 220 is then used to calculate the total grams of coating material “C” being dispensed from dispensing system 200.

Preferably, the total grams of coating material “C” dispensed onto the tray of needles is displayed on interface 304. More preferably, gravity feed system 300 can be provided with an automatic cut-off circuit or computer program 306 for regulating when to dispense coating material “C”. For example, in use, when scale 302 is originally “zeroed”, dispensing system 200 receives a “go” signal from computer program 306 thereby allowing for coating material “C” to be dispensed. Computer program 306 monitors the decrease in the weight of supply 220 such that when the weight of supply 220 is reduced by a threshold amount (e.g., corresponding to 16 or 19 grams), computer program 306 transmits a “no go” signal to dispensing system 200 indicating to dispensing system 200 to cease dispensing coating material “C” from dispensing head assembly 210.

With continued reference to FIGS. 5 and 6, as mentioned above, dispensing system 200 includes a purge cup 230 operatively associated therewith. In use, dispensing head assembly 210 rests in purge cup 230 when dispensing system 200 is idle. Preferably, purge cup 230 contains a quantity of solvent “S” therein. Suitable solvents “S” include and are not limited to at least one of a hydrocarbon solvent of from about 5 to about 10 carbon atoms, an alcohol, a hexane, a heptane, an isopropanol, and mixtures thereof.

In operation, when dispensing system 200 is idle (i.e., not dispensing coating material “C” from dispensing head assembly 210), dispensing head assembly 210 rests in purge cup 230 such that the distal tip of dispensing head assembly 210 is submerged in solvent “S”. In so doing, solvent “S” prevents clogging of discharge nozzle 44 by minimizing the exposure of discharge nozzle 44 to ambient moisture and thus minimizing any silicon cross linking of coating material “C” that may take place. Accordingly, the free flow of coating material “C” from discharge nozzle 44 improves the consistent repetitive recreation of the material flow pattern (e.g., tornadic, swirling, etc.) exiting therefrom.

With reference now to FIGS. 5 and 6, a preferred method of operation of dispensing system 200 is shown and described. In operation, a tray of needles 240, traveling on a conveyor 250 or the like, in the direction of arrow “X”, enters a spray hood 260 (shown in phantom in FIG. 5). Once tray of needles 240 is positioned at a desired and/or a predetermined location within spray hood 260, dispensing system 300 is activated to spray a layer of coating material “C” onto tray of needles 240.

Dispensing system 200 raises dispensing head assembly 210, originally maintained in purge cup 230, out of purge cup 230 and maneuvered over tray of needles 240 in a predetermined pattern so as to completely cover needles 242 with coating material “C”. Preferably, dispensing head assembly 210 is maneuvered over the target site, i.e., tray of needles 240, in a substantially rectilinear pattern (e.g., in the direction of arrows X′ and Y′).

Reference can be made to U.S. Pat. No. 6,244,522, previously incorporated herein by reference, for a detailed discussion of the operation of dispensing system 200. Preferably, coating material “C” is sprayed onto needles 242 until needles 242 are coated with a sufficient amount of coating material “C” or until the predetermined quantity of coating material (as determined by the reduction in weight of supply 220 as described above) has been dispensed and gravity feed system 300 transmits a “no go” signal to dispensing system 200, at which time the dispensation of coating material “C” is terminated for tray of needles 240.

If the desired quantity of coating material “C” has been deposited onto needles 242, the tray of needles 240 is further transported on conveyor 250 to the next stage of the manufacturing process. If, on the other hand, the desired quantity of coating material “C” has not been deposited on needles 242 of tray of needles 240, the tray of needles 240 is re-cycled and/or otherwise discarded.

Following, each application of coating material “C” to the tray of needles 240, dispensing head assembly 210 is returned to purge cup 230 such that the distal end of dispensing head assembly 210 is submerged in solvent “S”. In this manner, solvent “S” prevents and/or inhibits clogging of orifices 80 and air jets 82 (see FIGS. 4A and 4B) of discharge nozzle 44 between successive spraying steps.

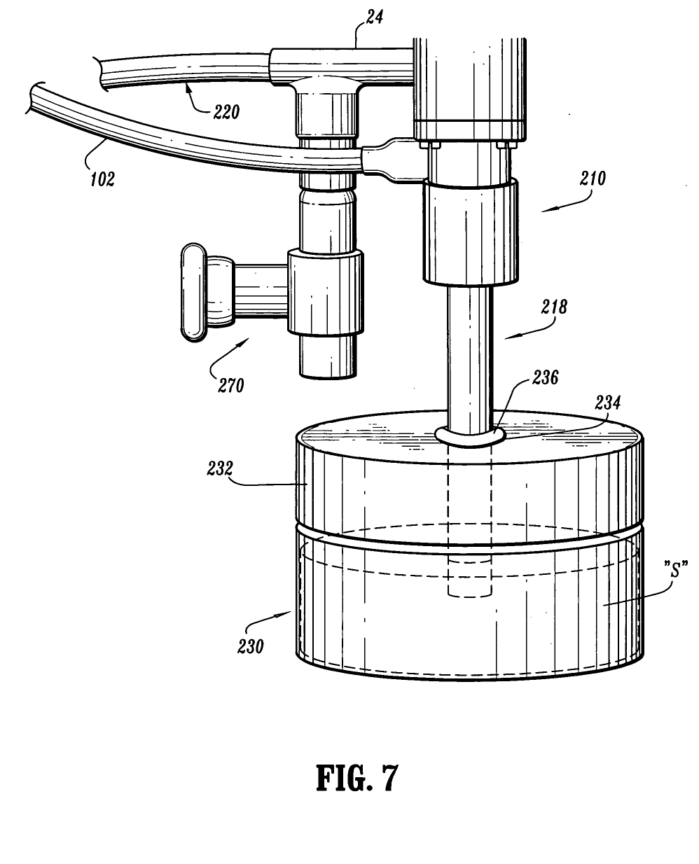

As seen in FIG. 7, purge cup 230 can be provided with a cap or lid 232 including an aperture 234 formed therein. Preferably, aperture 234 is sized to allow reception and/or passage of barrel assembly 218 of dispensing head assembly 210 therein. Preferably, barrel assembly 218 is provided with a sealing member 236, preferably in the form of an O-ring, disposed thereon. In this manner, when barrel assembly 218 is positioned in purge cup 230, seal member 236 effectively seals the perimeter of aperture 234 thereby inhibiting the escape and/or evaporation of solvent “S” from within purge cup 230.

As further seen in FIG. 7, dispensing system 200 further includes a purge valve 270 in operative association with port 24, preferably in fluid communication with conduit 222 interconnecting supply 220 of coating material “C” to port 24. Purge valve 270 can be either manually or automatically operated. Desirably, purge valve 270 functions to drain dispensing system 200 of coating material “C” without opening dispensing head assembly 210. Advantageously, by not opening dispensing head assembly 210, to drain dispensing system 200 of coating material “C”, the flow rate of coating material “C”, between successive runs and/or uses of dispensing system 200 is maintained substantially constant and/or the same.

The disclosure has been described with reference to preferred embodiments. Obviously, modifications and alterations will occur to others upon a reading and understanding of this specification. The present disclosure is intended to include all such modifications and alterations insofar as they come within the scope of the appended claims or the equivalents thereof.

1. A system for dispensing a quantity of a coating material, comprising:
a dispensing head assembly maneuverable over a target object; and
a purge cup operatively positioned relative to the dispensing head assembly, the purge cup defining a cavity for receiving a quantity of a solvent therein, wherein a nozzle of the dispensing head is positioned in the cavity of the purge cup when the system is in an idle condition.

2. The system according to claim 1, further comprising a supply of coating material operatively associated with the dispensing head assembly.

3. The system according to claim 2, wherein the coating material includes a silicone based coating material.

4. The system according to claim 3, wherein the coating material comprises a coating mixture including at least one polydialkylsiloxane having a molecular weight of at least about 10,000 cp and at least one other siliconization material.

5. The system according to claim 4, wherein the siliconization material is aminoalkyl siloxane and at least one other siloxane copolymerizable material.

6. The system according to claim 5, wherein the siloxane copolymerizable material is polydimethylsiloxane having amino and alkoxy functional groups.

7. The system according to claim 2, further comprising a gravity feed system for determining at least one of the amount and quantity of the coating material to be dispensed onto the target object.

8. The system according to claim 7, wherein the gravity feed system includes a scale for supporting the supply of coating material.

9. The system according to claim 8, wherein at least one of the amount and quantity of the coating material to be dispensed onto the target object is calculated from a decrease in weight of the supply of coating material.

10. The system according to claim 9, wherein the gravity feed system is calibrated to dispense about 19 grams of coating material for each target object.

11. The system according to claim 10, wherein each target object includes a plurality of surgical needles each having a thickness of 0.012 to about 0.067 inches.

12. The system according to claim 9, wherein the gravity feed system is calibrated to dispense about 16 grams of coating material for each target object.

13. The system according to claim 12, wherein each target object includes a plurality of surgical needles each having a thickness of about 0.006 to about 0.011 inches.

14. The system according to claim 9, wherein the scale measures the decrease in weight of the supply of coating material.

15. The system according to claim 14, wherein the gravity feed system includes an algorithm for converting the loss in weight of the supply of coating material to the quantity of coating material dispensed.

16. The system according to claim 15, wherein the target objects include at least one of a plurality of needles and a tray having a plurality of needles connected thereto.

17. The system according to claim 15, further comprising a conveyor for carrying the target objects thereon.

18. The system according to claim 17, further comprising a hood configured to surround the target object during the dispensing of the coating material thereon.

19. The system according to claim 3, further comprising a solvent disposed in the cavity of the purge cup, wherein the solvent is of the type for inhibiting clogging of a distal end of the dispensing head assembly when the distal end of the dispensing head assembly is disposed in the solvent contained in the purge cup.

20. A method for coating a target object with a coating material, comprising the steps of:
providing a dispensing system including:
a dispensing head assembly;
a supply of coating material operatively connected to the dispensing head assembly; and
a purge cup containing a quantity of a solvent therein and for retaining a portion of the dispensing head assembly therein when the dispensing system is idle;
removing the dispensing head assembly from the solvent of the purge cup;
positioning the dispensing head assembly over a target object;
dispensing a predetermined quantity of coating material onto the target object;
maneuvering the dispensing head assembly over the target object in a predetermined pattern; and
returning the dispensing head assembly to the purge cup such that a distal end portion of the dispensing head assembly is submerged below the surface of the solvent.

21. The method according to claim 20, further comprising the step of terminating the dispensing of the coating material after a predetermined amount of coating material has been dispensed.

22. The method according to claim 21, wherein the gravity feed system includes a scale for measuring a decrease in the weight of the supply of coating material.

23. The method according to claim 22, wherein the gravity system includes an algorithm for converting the loss in weight of the supply of coating material to the quantity of coating material dispensed.

24. The method according to claim 23, further comprising the step of:
transmitting a “no go” signal, from the gravity feed system to the dispensing system, when a predetermined quantity of coating material has been dispensed, wherein the “no go” signal terminates the dispensing of the coating material.

25. A dispensing system for dispensing a quantity of a coating material, comprising:
a dispensing head assembly including:
a sleeve defining a material supply passageway to receive the coating material;
an inner barrel disposed within the sleeve and defining an air passageway between the sleeve and the inner barrel; and
a nozzle operatively supported on a distal end of the sleeve in a fluid tight manner, the nozzle having an orifice through which coating material from the supply passageway is dispensed, the nozzle having an annular flange with air ports formed therein and in fluid communication with the air passageway;
a reservoir for containing a quantity of coating material therein, wherein the reservoir is fluidly connected to the dispensing head assembly; and
a gravity feed system including a scale for supporting the reservoir, wherein the gravity feed system determines the quantity of coating material dispensed from the dispensing head assembly.

26. The dispensing system according to claim 25, further comprising:
a purge cup including a solvent material therein, wherein the nozzle is disposed within the solvent of the purge cup when the dispensing head assembly is idle.

27. The dispensing system according to claim 26, wherein the solvent material reduces the exposure of the nozzle to ambient moisture and minimizes silicon cross linking of the coating material.

28. The dispensing system according to claim 27, wherein the gravity feed system includes a cut-off circuit for regulating the quantity of coating material dispensed from the reservoir.

29. The dispensing system according to claim 28, wherein the cut-off circuit transmits a “go” signal when coating material is to be dispensed and a “no go” signal when coating material is not to be dispensed.

30. The dispensing system according to claim 29, wherein the cut-off circuit monitors the scale during dispensing of the coating material from the reservoir, wherein when the scale reaches a threshold level, the cut-off circuit transmits a “no go” signal and terminates dispensing of the coating material from the reservoir.

31. The dispensing system according to claim 29, wherein the solvent is at least one of a hydrocarbon solvent of from about 5 to about 10 carbon atoms, an alcohol, a hexane, a heptane, and an isopropanol.
